(19) United States
(12) Patent Application Publication
(10) Pub. No.: US 2017/0004948 A1
(43) Pub. Date: Jan. 5, 2017

(54) ELECTRICAL CIRCUIT PROTECTOR

(71) Applicant: Google Inc., Mountain View, CA (US)

(72) Inventor: Gregory E. Leyh, Brisbane, CA (US)

(73) Assignee: Google Inc., Mountain View, CA (US)

(21) Appl. No.: 13/798,732

(22) Filed: Mar. 13, 2013

(51) Int. Cl. H01H 89/00

(52) U.S. Cl. CPC H01H 89/00

(57) ABSTRACT

A circuit protection device includes a solid-state interrupter that is operable to open a circuit within a specified response time upon detection of a fault current state. A mechanical interrupter is connected in series with the solid-state interrupter. The mechanical interrupter is operable to open the circuit subsequent to the opening operation of the solid-state interrupter. A controller is coupled with the solid-state interrupter and the mechanical interrupter. The controller is operable to detect the fault current state in the circuit and to control the mechanical interrupter for coordinated operation with the solid-state interrupter. In some implementations, the response time is between two microseconds and twenty microseconds. The mechanical circuit breaker can safely physically open the circuit at a low breaking current (e.g., the solid-state interrupter quickly opens the circuit and prevents current from surging to dangerous levels).

### TECHNICAL BACKGROUND

This disclosure relates to electrical circuit protection.

### BACKGROUND

Electrical power generation and transmission systems require current control and fault limiting devices to prevent a fault current from damaging the systems. Circuit breakers can automatically open/interrupt the electrical circuit upon detecting a fault current state (e.g., an excessive surge in current magnitude). Circuit breakers can be categorized in various voltage ranges, as well as in different interruption methods. Different interruption methods can result in different response time required to open/interrupt the electrical circuit. An arc may develop during the interruption. The shorter the response time, the less powerful the arc, and the better the circuit protection.

### SUMMARY

In a general aspect, a circuit protection device includes a solid-state interrupter that is operable to open a circuit within a specified response time upon detection of a fault current state. A mechanical interrupter is connected in series with the solid-state interrupter. The mechanical interrupter is operable to open the circuit subsequent to the opening operation of the solid-state interrupter. A controller is coupled with the solid-state interrupter and the mechanical interrupter. The controller is operable to detect the fault current state in the circuit and to control the mechanical interrupter for coordinated operation with the solid-state interrupter.

The general aspect may further include one or more of the following features, alone or in combination with other aspect(s). The specified response time for the solid-state interrupter to open the circuit can be between one microsecond and five hundred microseconds. In some implementations, the response time is between two microseconds and twenty microseconds. The controller can include an interlock logic operable to receiver a signal from the solid-state interrupter indicating an opening of the circuit by the solid-state interrupter. The interlock logic can in response command the mechanical interrupter to open. When closing, the interlock logic can command the mechanical interrupter to close the circuit prior to commanding the solid-state interrupter to close the circuit.

The general aspect may further include one or more of the following features, alone or in combination with other aspect(s). The interlock logic is further operable to automatically reset the mechanical interrupter to a closed status and to subsequently close the solid-state interrupter when the alternating voltage of the circuit reaches zero. The circuit protection device can further include at least one current sensor operable to measure current magnitude and a first temporal derivative of the current magnitude. The at least one current sensor is operable to separately calculate a first temporal derivative based on the measured current magnitude for determining the fault current state. In some implementations, the mechanical interrupter includes a vacuum interrupter. The circuit protection device can be deployed in a single phase of a three-phase electric power device.

Various implementations of a fast acting electrical circuit protector may include one or more of the following features. For example, the fast acting electrical circuit protector can be used in medium-voltage-low-current (MVLC) applications, such as applications related to data centers. One or more insulated-gate bipolar transistors (IGBT) can be included in the solid-state interrupter to quickly switch the circuit to an open state. The mechanical circuit breaker can safely physically open the circuit at a low breaking current (e.g., the solid-state interrupter quickly opens the circuit and prevents current from surging to dangerous levels). This can effectively reduce arc generation and reduce chances for personal injury and equipment damage. The configuration of having a mechanical circuit breaker connected in series with a solid-state interrupter also allows for resetting and closing the circuit when the alternating voltage reaches zero, greatly reducing surge currents, stresses on conductors and electromagnetic interference.

The details of one or more implementations of the subject matter of this disclosure are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example power supply system with a fast acting electrical circuit protector;

FIG. 2 is an example circuit diagram of the circuit protector of FIG. 1;

FIG. 3 is an example detailed circuit diagram of one phase of the circuit protector illustrated in FIG. 2;

FIG. 4 shows a graph of current versus time in the example circuit diagram of FIG. 3;

FIG. 5 is a flow chart showing an example process for fast acting circuit protection; and

FIG. 6 is a schematic diagram of an example implementation of a circuit protector.

### DETAILED DESCRIPTION

This disclosure describes implementations of an electrical circuit protector. In some example implementations, the electrical circuit breaker includes one or more solid-state interrupters positioned on respective phases of a three-phase circuit (or a single solid-state interrupter positioned on a single phase circuit). In series with each respective solid-state interrupter is a mechanical interrupter (e.g., a vacuum breaker or otherwise) positioned on the respective phases. The solid-state interrupter and mechanical interrupter are communicably coupled to a controller (e.g., a single controller or a controller per phase) that is configured to determine a fault state on a particular phase. The controller is configured to, in response to the fault state, initiate opening of the phase by the solid-state interrupter and then the mechanical interrupter.

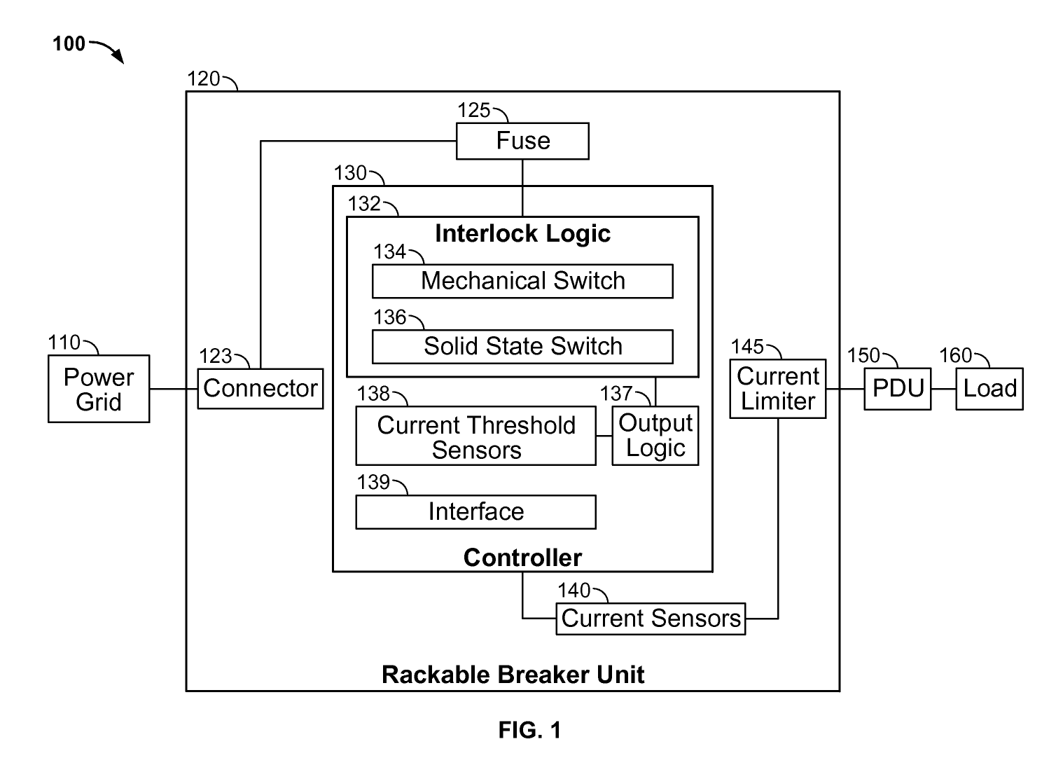

FIG. 1 is a block diagram of an example power supply system 100 with a fast acting electrical circuit protector 120. The power supply system 100 receives power from a power grid 110 and supplies power through the circuit protector 120 to a power distribution unit (PDU) 150. The PDU then supplies power to a load 160, such as a data center. In general, the power grid 110 can supply alternating-current (AC) electrical power (e.g., 480 V at 60 Hz). The circuit protector 120 can protect the connection between the power grid 110, the PDU 150, and the load 160. For example, the circuit protector 120 can prevent damage by quickly disconnecting (e.g., within microseconds) power supply to the load 160. The disconnection isolates faults from the power grid 110. The circuit protector 120 can be a rackable breaker unit that simultaneously controls the three AC phases in the system 100. Although illustrated as a single PDU 150, two or more PDUs 150 can be included in connection with the power grid 110. Each of the two or more PDUs 150 can be provided with a corresponding circuit protector 120 and be connected to a corresponding load 160.

The example circuit protector 120 includes a solid-state switch 136 connected in series with a mechanical switch 134. Both the solid-state switch 136 and the mechanical switch 134 are communicably coupled to a controller 130. The solid-state switch 136 can react to a fault state and interrupt the circuit in a short response time (e.g., about five microseconds). The mechanical switch 134 then opens to maintain the disconnection. Because of the short response time, the solid-state switch can limit the current surge and the mechanical switch 134 can open the circuit at close to zero current. This can help in reducing/avoiding arc generation that would happen were the disconnection current high (e.g., over tens of thousands of amperes). The mechanical switch 134 is coordinated to operate with the solid-state switch in the controller 130 as further discussed below.

The circuit protector 120 also includes a connector 123, a fuse 125, one or more current sensors 140, and a current limiter 145. The connector 123 is a set of hardware providing connection in each phase between the circuit protector 120 and the power grid 110. In some implementations, the connector 123 allows the circuit protector 120 to be removed or replaced. The fuse 125 provides a backup protection to the system 100 in case the solid-state switch 136 and/or the mechanical switch 134 fail to operate. The current sensors 140 can measure the electrical current in the circuit and send the measurement information to the controller 130. The measurement information may be used in the controller 130 to determine if a fault state has occurred. The current limiter 145, such as an inductor, can restrict drastic current variations in the system 100 by setting a maximum allowable rate of current change.

The controller 130 includes an interlock logic 132, and output logic 137, a current threshold sensor 138, and an interface 139. The current threshold sensor 138 can receive the current measurement signal from the current sensors 140 and perform derivative calculations for the rate of change. The calculated rate of change is compared to a threshold value. The comparison result is sent to the output logic 137 that may trigger the solid-state switch 136 to act. For example, a rate of change greater than the threshold value can trigger operations of the solid-state switch. The threshold value can be changed at the interface 139 by user input. Upon detecting a fault state in the system 100, the solid-state switch 136 quickly opens the system circuit and sends a signal to the interlock logic 132. The interlock logic 132 then commands the mechanical switch 134 to open, for example, by actuating a solenoid mechanism of the mechanical switch 134. The interface 136 can be a programmable logic controller interface.

The interlock logic 132 can interlock the solid-state switch 136 and the mechanical switch 134 with each other. A particular sequence may be implemented. For example, when opening a circuit, the mechanical switch 134 opens subsequent to the solid-state switch 136; and when closing a circuit, the mechanical switch 134 closes prior to the solid-state switch 136. This can be advantageous for at least two reasons. First, the solid-state switch 136 can open the circuit upon detection of a fault current state in a very short specified time period, but does not physically disconnect the circuit. The mechanical switch 134 can, upon receiving instructions from a controller subsequent to the opening of the solid-state switch 136, physically disconnect the circuit. Second, after closing the circuit with the mechanical switch 134, the solid-state switch 136 can subsequently close the circuit at the exact moment when the alternating voltage reaches zero. This allows the power/current to smoothly ramp-up.

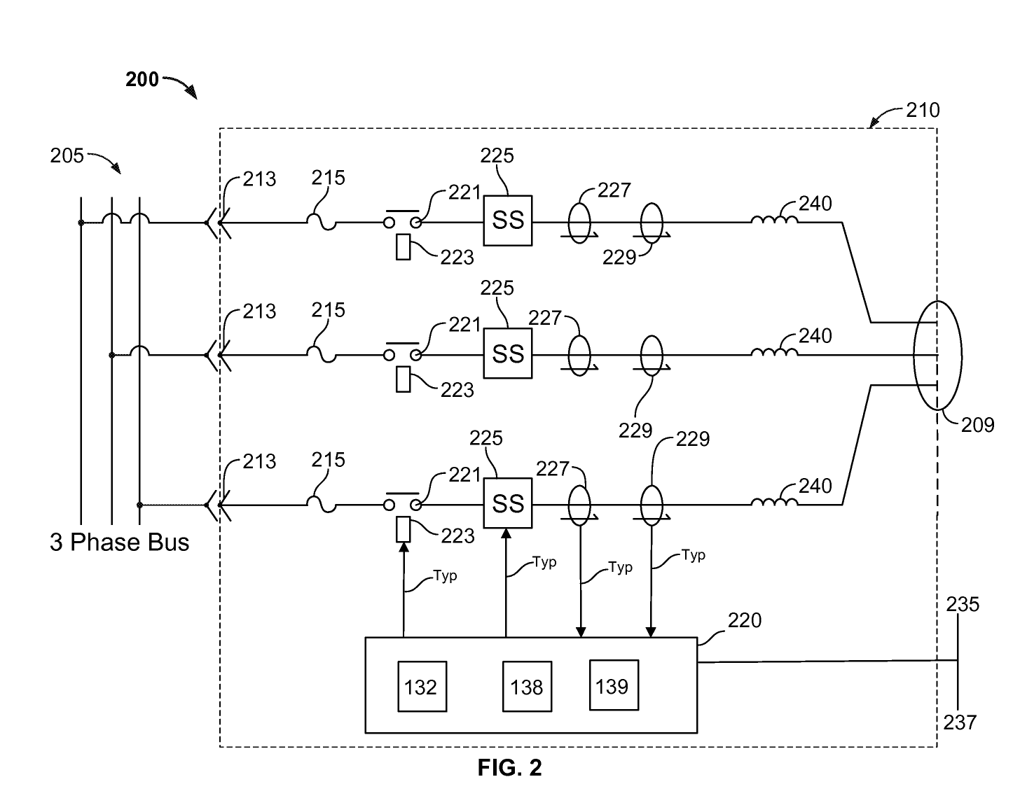

FIG. 2 is an example circuit diagram of the circuit protector of FIG. 1. The example circuit diagram 200 includes a three-phase bus 205 rated at 4160 V and 4000 A. The power is transferred through a circuit protector 210 to a PDU 209. Each phase of the bus 205 includes its own circuit protector and related circuit components. For example, each phase is connected with a connector 213, a fuse 215, a controller 220, and a current limiter 240. The illustrated controller 220 further includes the following components connected in series: a mechanical interrupter 221 with an actuation solenoid 223, a solid-state interrupter 225, a current transformer 227, and a current derivative sensor 229. The controller 220, in some aspects, is separately powered by a power supply 235 and is connected with a network 237.

In general, the power supply 235 can provide AC power (e.g., 110 V, 60 Hz) with backup systems. The network 237 enables the controller 220 to communicate with external terminals to report status and to intake instructions. The connector 213 can be mechanical stabs (e.g., copper plates slide-able into terminal contact) or other connection hardware for connecting or disconnecting the circuit protector with the three-phase bus 205 when the circuit is open (e.g., no current). The fuse 215 can have an appropriate rating of maximum allowable current to protect the circuit when other forms of protection fail or are not able to respond in time. The current rating of the fuse 215 may be slightly higher than the current rating for the solid-state interrupter 225 and/or the mechanical interrupter 221. For example, the solid-state interrupter 225 may have an allowable current rating of 10 A; and the fuse 215 may have an allowable current rating of 15 A.

At a high level, the current in each phase of the example circuit is monitored by the controller 220 that may receive data signals from the current transformer 227 and the current derivative sensor 229. When the current becomes excessively high (e.g., higher than a permissible rating), the solid-state interrupter 225 can quickly and automatically open the circuit. The current transformer 227 and the current derivative sensor 229 can send the excessive current signal to the controller 220, which can then determine the circuit needs to open and send instructions to the actuation solenoid 223 to have the mechanical interrupter 221 physically open the circuit. Because the response time for the solid-state interrupter 225 to open the circuit is very short relative to the opening of the actuation time of the solenoid 223, the increase of the excessive current can be limited to a manageable level and the mechanical interrupter 221 can safely break the circuit at near zero current (e.g., the magnitude of the resulting arc current is reduced relative to the magnitude that would result in the absence of the solid-state interrupter 225).

The illustrated solid-state interrupter 225 includes an electronic circuit board for switching the circuit off upon excessive current. In some implementations, the solid-state interrupter 225 can include an IGBT or other transistors that can switch rapidly (e.g., in microseconds). The response time period for the IGBT can be much shorter than the mechanical interrupter 221 response time period (e.g., in milliseconds). In response to an excessive current magnitude or rate of change, the solid-state interrupter 225 can automatically switch to open the circuit. Upon triggering of the solid-state interrupter 225, a disconnection signal is sent to the controller 220 for further triggering the mechanical interrupter 221 to physically open the circuit. The controller 220 may also use signals from the current transformer 227 and/or the derivative sensor 229 to determine if a fault state has actually occurred.

The illustrated current transformer 227 measures the electrical current magnitude in the system and can be any standard current transformer. The current derivative sensor 229 measures the rate of change of the electrical current; for example, the current derivative sensor 229 can be a Rogowski coil. The current transformer 227 and the derivative sensor 229 feed measurement signals to the controller 220 for detecting a fault state in the system. For example, a fault state can occur when the system is overloaded or the circuit is shorted. The fault state can be indicated with a large magnitude current (e.g., when circuit is overloaded) or with a high rate of change (e.g., when circuit is shorted). The high rate of current change of the fault state would be orders of magnitude greater than a rate of current change caused by a regular load. The rate of current change signal can thus be used to predictively determine the fault state. Either the current magnitude signal or the rate of change signal can trigger the interrupters to operate. For example, the solid-state interrupter 225 can be triggered (e.g., switched to open the circuit) when a fault state is detected. In some implementations, the solid-state interrupter 225 includes its own current detection circuit for triggering its own operation. The controller 220 may use the rate of current change signal to predictively actuate the mechanical interrupter 221 to open the circuit, regardless if the solid-state interrupter 225 has been triggered.

In some implementations, either the disconnection signal from the solid-state interrupter 225, the fault current state signals from the current derivative sensor 229, and/or the current transformer 227 can be used in the controller to trigger the mechanical interrupter 221. An interlock logic may be used to tie the solid-state interrupter 225 with the mechanical interrupter 221 for triggering disconnection in the mechanical interrupter 221 using the disconnection signal. And an output logic may be used in the controller 220 to open the mechanical interrupter 221 when the fault current state signals exceed predetermined threshold values.

In operation, for example, a fault current state can be indicated by a sudden current surge at about 50 amperes per microsecond. The solid-state interrupter 225 can react to the surge in about five microseconds, disconnecting the circuit at two hundred and fifty amperes. After the solid-state interrupter 225 has opened the circuit, the mechanical interrupter 221 can physically disconnect the circuit in about one hundred milliseconds (or a tenth of a second), using the solenoid 223. In some implementations, the solenoid 223 may also be used to automatically reset the mechanical interrupter back to a closed status after a predefined period of time, or when the controller receives a reset command from a user/administrator (e.g., at a local interface or from the network 237).

The mechanical interrupter 221 can be an automated switch using a mechanical trip mechanism. For example, the mechanical interrupter 221 may be a vacuum circuit breaker, a miniature low-voltage circuit breaker, a gas circuit breaker, or an air circuit breaker. Depending on application, different types of circuit breakers may be selected based on specific features. For instance, vacuum circuit breakers have minimal arcing due to the absence of material for ionizing besides the contact material. Current and/or voltage rating may be another aspect for selecting application dependent circuit breakers. Magnetic circuit breakers, thermal magnetic circuit breakers, trip breakers, and mechanical circuit breakers using various breaking mechanisms can be used. For example, a magnetic circuit breaker is illustrated in FIG. 2 having the solenoid 223 to actuate the mechanical interrupter 221. The solenoid 223 can switch the mechanical interrupter 221 on or off upon receiving instruction signals from the controller 220. The mechanical interrupter 221 may include automatic resetting functions to reset the switch to the closed state, for example, when a time-out period has expired after disconnection. The mechanical interrupter 221 may also receive instruction signals from the controller 220 for resetting to the closed state.

The controller 220 may include one or more processors, memories, interfaces, and other circuit components. The controller 220 can effectively interlock the solid-state interrupter 225 and the mechanical interrupter 221, for example, with minimal time delay, when one switches, the other one switches correspondingly to the same state. During operation, the controller 220 can determine if conditions for tripping the mechanical interrupter 221 are met by monitoring and analyzing the electric current data sent from the current transformer 227 and the derivative sensor 229, and/or receiving a switch signal from the solid-state interrupter 225. The status of each component and its data can be used for generating reports for administrators. The reports may be sent through the network 237.

Similar to the controller 130 of FIG. 1, the controller 220 can also include an interlock logic 132, a current threshold sensor 138, and an interface 139. The interlock logic 132 can tie the solid-state interrupter 225 and the mechanical interrupter 221 together in the same response state. For example, the interlock logic 132 allows the controller 220 to command the mechanical interrupter 221 to open subsequent to the opening operation of the solid-state interrupter 225, and to command the solid-state interrupter 225 to close subsequent to the closing (e.g., upon resetting the circuit) operation of the mechanical interrupter 221. The solid-state interrupter 225 can close the circuit when the alternating voltage reaches zero. The current threshold sensor 138 can determine if the current magnitude detected at the current transformer 227 and/or the current rate of change detected at the Rogowski coil 229 have exceeded a predefined threshold value. In some implementations, the current threshold sensor 138 provides the controller 220 for fast fault detection. The interface 139 can be a programmable logic controller that enables an administrator to interact with the controller 220. For example, an administrator may configure settings, examine the status, generate reports, and perform other tasks by direct input or remote control via the network 237. For example, current threshold value defining a fault current state may be set at the interface 139. In some implementations, the interface 139 may be used to manually connect or disconnect the circuit.

A remote terminal may also access the controller 220 using the interface 139 through the network 237. In some implementations, an administrator may operate at the remote terminal to reset the mechanical interrupter 221 and/or the solid-state interrupter 225. In some implementations, the controller 220 may include self-diagnostic functions to determine if the circuit can be reconnected, or if default reset conditions are met. Default reset conditions may include time lapse after actuation of the solid-state interrupter 225, time lapse after switching off the mechanical interrupter 221, and/or time lapse after detection of the fault state.

Although the controller 220 and its components are illustrated in FIG. 2, other configurations are possible. For example, different electrical current sensors may be used in connection with the controller 220. In some implementations, an ampere meter can be used instead of the current transformer 227. The derivative sensor 229 may be replaced or removed by using a data processor in the controller 220 to digitally calculate the rate of change in real time. The solid-state interrupter 225 may be integrated as part of the circuit of the controller 220. And the controller 220 may be configured to adapt to the power provided by the bus 205 instead of using a separate power supply 235.

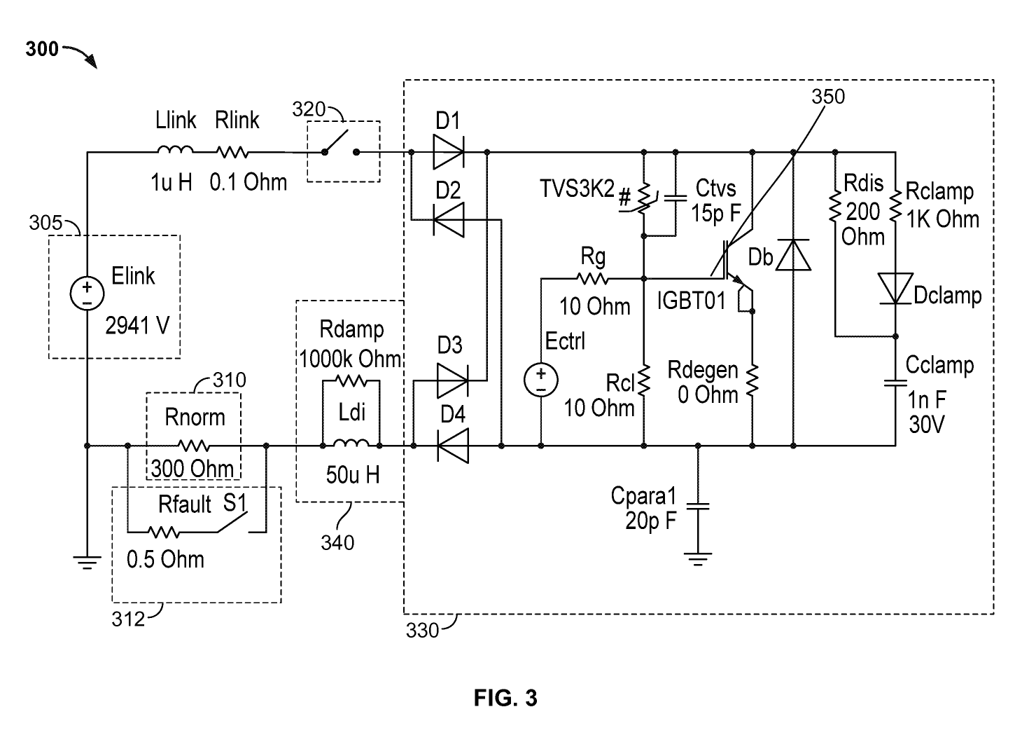

FIG. 3 is an example detailed circuit diagram 300, a portion of which may be substantially similar to the circuit protector 210 illustrated in FIG. 2. For example, diagram 300 includes a mechanical interrupter 320 arranged in series with a solid-state interrupter 300, both of which are electrically coupled to a power source 305 (e.g., at 2941 V). The power source 305 provides power to a nominal load 310. The nominal load 310 is paralleled with a fault state load 312, which can introduce a fault current state to the circuit. For example, the fault state load 312, upon closure of switch S1, (e.g., at a time zero) creates a current surge. The circuit diagram 300 further includes a current limiter 340 for limiting the circuit current from changing drastically. For instance, the current limiter 340 can place a finite limit on the rate of current change, allowing for response time for external controllers.

The mechanical interrupter 320 can be controlled by an external controller not shown in the circuit diagram 300 (e.g., controller 220). The external controller can receive a switch signal from the solid-state interrupter 330 when the solid-state interrupter 330 switches upon detection of a fault state and instruct the mechanical interrupter 320 to physically disconnect the circuit. The switch signal can be an on/off signal having a step voltage profile. The solid-state interrupter 320 further includes an IGBT 350 that can quickly switch the circuit to open when a fault state is detected (e.g., when the switch Si of the load 312 is closed). The IGBT 350 may be replaced with other high-voltage transistors or bilateral switches. The additional components around the IGBT 350 can provide circuit protection to the IGBT 350. In FIG. 3, a number of diodes are implemented for regulating current direction. In some implementations, two regular transistors may be arranged in opposite configuration to allow for responding to current in different directions.

Although FIG. 3 illustrates detail components for the circuit protector, different configurations are possible. For example, components labeled Cₜᵥₛ, R_{cl}, R_{dis}, R_{clamp}, D_{clamp}, and C_{clamp} can be omitted in some implementations. In some implementations, however, other components may be added to the circuit protector for additional protection, monitoring, or other control purposes.

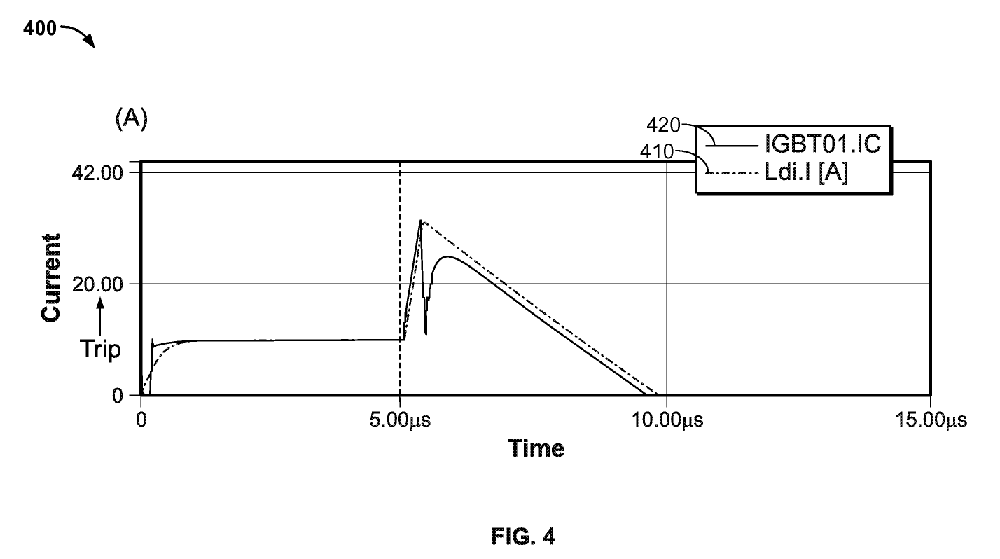

FIG. 4 shows a graph 400 of current versus time during operation of the circuit diagram 300 of FIG. 3. The horizontal axis indicates time, and the vertical axis represents current magnitude. Two current profiles are shown: circuit current 410, and IGBT current 420. The operation starts at time zero, when the circuit of FIG. 3 is closed (e.g., the mechanical interrupter 320 is closed and the fault state load 312 is not engaged) and normal operation is conducted. The normal operation reaches a steady current at about 10 A. At the start, the circuit current 410 rises linearly while the IGBT current 420 rises at the first instance when the alternating voltage reaches zero.

At 5 microseconds, the fault state load 312 is applied to the circuit by closing the introduction switch Si. After the fault state is introduced, the circuit current 410 has an initial surging profile at a high rate about 50 A/microsecond. The solid-state interrupter 330 opens the circuit within about 5 microseconds and causes both the circuit current 410 and the IGBT current 420 to decline to zero. If a mechanical interrupter were used in the place of the solid-state interrupter 330, the opening action would take place at about 100 millisecond instead of 5 microsecond, allowing the current to surge up to 20,000 times more (assuming a linear current surge). Therefore the solid-state interrupter 330, in this example, can safely open the circuit at low current magnitude, which also facilities the subsequent opening of the mechanical interrupter 320 at near zero current (e.g., the solid-state interrupter 330 ramps the fault current to near zero).

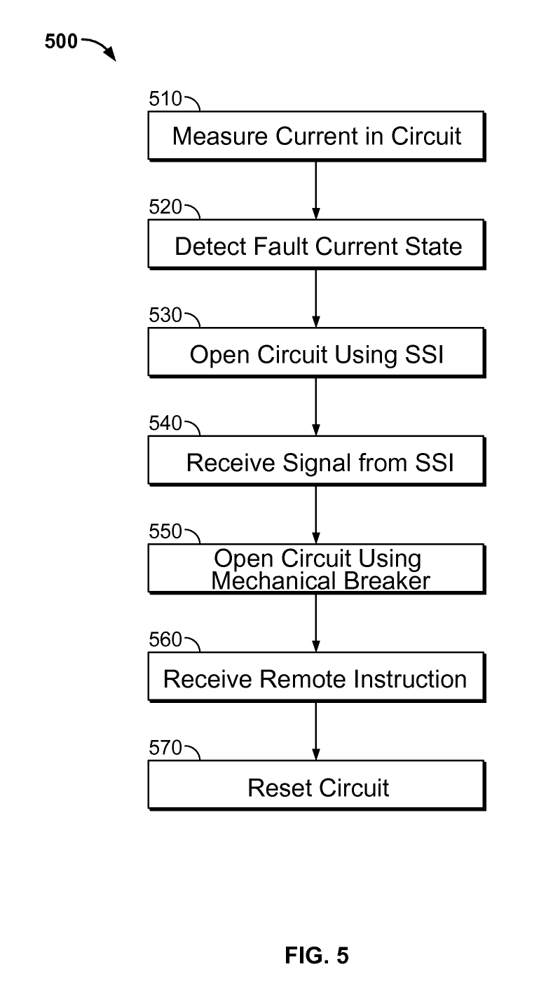

FIG. 5 is a flow chart 500 showing an example process for fast acting circuit protection. The example process can be used by an electrical circuit protector to interrupt and open a circuit when a fault state is detected. At 510, the electrical current in the circuit is measured. The electrical current may be measured using a current sensor, such as a current transformer for magnitude and/or a Rogowski coil for rate of change in magnitude. In some implementations, the current sensor may be external to the electrical circuit protector and sends measurement signal to the electrical circuit protector. The current measurement can be either analogue or digital. The current sensor may be connected to the circuit in series (e.g., as in an ampere meter) or may be external to the circuit (e.g., as in a current transformer). The rate of change may be derived from a continuous measurement of magnitude. For example, a continuous measurement at a constant sampling rate can be used in calculation of temporal derivative for rate of change. The electrical circuit protector can monitor the level of current magnitude and the rate of change for detecting a current fault state.

At 520, a fault current state is detected. The fault current state may be determined based on the current magnitude or the current rate of change exceeding a predefined threshold value. For example, when the circuit is overloaded, the current may increase to exceed the allowable current threshold value. In other instances, when the circuit is shorted, the current may surge at a very high rate of change that exceeds the allowable rate of change threshold value. The current rate of change can be calculated based on a temporal derivative of the current magnitude. The current magnitude and the rate of change may be measured separately, or only the current magnitude is measured at a high sampling rate for calculations of its temporal derivative. The fault current state detection may be performed at the circuit protector by monitoring current magnitude with a current transformer and rate of change signals with a Rogowski coil. The circuit protector may include a current threshold sensor to determine if each measured value has exceeded a corresponding predefined threshold value. In some implementations, the circuit protector may further include a programmable logic controller interface for an administrator to change and/or define one or more threshold values.

In addition to current sensors, the fault current state may also be determined based on the reaction of a solid-state interrupter (SSI) opening the circuit. For example, the SSI can be the first component in the circuit protector to react to the fault state (e.g., within about 5 microseconds). The opening of the circuit by the SSI can register the fault state in the circuit protector and initiate subsequent responses (e.g., including sending commands to physically disconnect the circuit). The circuit protector may include an output-to-logic module to select and/or respond to the trigger signal of the highest priority, among the current magnitude, the rate of change, and the signal from the SSI.

At 530, the circuit is opened using the SSI, which can include a high voltage transistor (e.g., IGBT) to interrupt the fault current state. The S SI can open the circuit in a specified response time. For example, the specified response time can be about 5 microseconds or less. In some implementations, the specified response time is between about 2 and about 20 microseconds, and in other implementations, the specified response time is between about 1 microsecond and about 500 microseconds. The short response time can significantly limit the current surge. For example, in a fault state, the current may start surging at 50 ampere per microsecond. Opening the circuit within 5 microseconds can limit the breaking current at 250 amperes. In comparison, a mechanical circuit breaker takes about 100 milliseconds to break a circuit.

At 540, the circuit protector receives a trigger signal from the SSI. The signal can be an on/off signal having a normal level and a step up/down to indicate the triggering has happened. The signal may cause the circuit protector to send a trigger signal to a mechanical circuit breaker/interrupter that is connected in series with the SSI. For example, the circuit protector includes a controller that can interlock the states between the SSI and the mechanical circuit breaker. The signal sent to the mechanical circuit breaker may also be an on/off signal having a normal level and a step up/down to cause a trigger. The circuit protector may also include a level

At 550, upon receiving the trigger signal from the SSI, the circuit protector commands the mechanical circuit breaker to open the circuit. The mechanical circuit breaker may be a solenoid controlled vacuum circuit breaker, or any appropriate mechanical circuit breaker. In some implementations, current data signals sent from the current sensors may also cause the circuit protector to determine that the circuit needs to be physically disconnected. The circuit protector may also receive instructions from administrative users via a network or local interface to disconnect the circuit using the mechanical circuit breaker.

At 560, the circuit protector may receive remote instruction to reset the circuit. For example, after the circuit is physically disconnected, a status report is sent to an administrative user. The administrative user may inquire or examine the circuit status and send instructions to reset the circuit.

At 570, the circuit protector can reset the circuit in response to the instruction. In some implementations, the circuit protector may automatically reset the circuit when certain conditions are met. For example, the circuit protector may reset the circuit after a predefined period of time has lapsed. Other input to reset the circuit is possible. Upon resetting, the circuit protector can close the phase of the circuit when the alternating voltage of the circuit reaches zero.

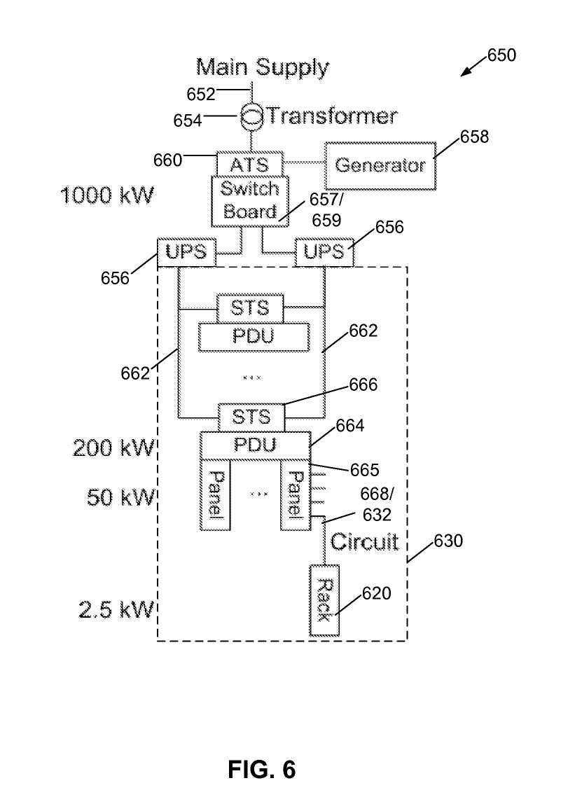

FIG. 6 is a schematic diagram 600 of an example implementation of a circuit protector described above. FIG. 6 shows a power distribution system 650 of an example Tier-2 datacenter facility with a total capacity of 100KW. The rough capacity of the different components is shown on the left side. A medium voltage feed 652 from a substation is first transformed by a transformer 654 down to 480 V. It is common to have an uninterruptible power supply (UPS) 656 and generator 658 combination to provide back-up power should the main power fail. The UPS 656 is responsible for conditioning power and providing short-term backup, while the generator 658 provides longer-term back-up. An automatic transfer switch (ATS) 660 switches between the generator and the mains, and supplies the rest of the hierarchy. From here, power is supplied via two independent routes 662 in order to assure a degree of fault tolerance. Each side has its own UPS that supplies a series of power distribution units (PDUs) 664. Between ATS 660 and UPS 656 is an electric switchboard 657 integrated with one or more circuit protector 659 on each phase of the UPS 656. The circuit protector 659 can be the circuit protector 210 of FIG. 2. In some implementations, the circuit protector 659 can also be placed in or about the distribution panel 665 at 50-200 kW level as discussed below.

Each PDU is paired with a static transfer switch (STS) 666 to route power from both sides and assure an uninterrupted supply should one side fail. The PDUs 664 are rated on the order of 75-200 kW each. They further transform the voltage (to 110 or 208 V in the US) and provide additional conditioning and monitoring, and include distribution panels 665 from which individual circuits 668 emerge. The distribution panels 665 can include a circuit protector 659 for each phase. The circuit protector 659 can provide circuit protection to the feeding line 632. Circuits 668, which can include the power cabling 638, power a rack or fraction of a rack worth of computing equipment. The group of circuits (and non-illustrated bus bars) provides the power grid 630 to a data center. The data center requires medium voltage and low current applications, for which the circuit breaker can provide fast acting protection. Thus, there can be multiple circuits per module and multiple circuits per row. Depending on the types of servers, each rack 626 can contain between 610 and 680 computing nodes, and is fed by a small number of circuits. Between 620 and 660 racks are aggregated into a PDU 664.

Power deployment restrictions generally occur at three levels: rack, PDU, and facility. (However, as shown in FIG. 6, four levels may be employed, with 2.5KW at the rack, 50KW at the panel, 200KW at the PDU, and 1000KW at the switchboard.) Enforcement of power limits can be physical or contractual in nature. Physical enforcement means that overloading of electrical circuits will cause circuit breakers to trip, and result in outages. Contractual enforcement is in the form of economic penalties for exceeding the negotiated load (power and/or energy).

Physical limits are generally used at the lower levels of the power distribution system, while contractual limits may show up at the higher levels. At the rack level, more circuit breakers protect individual power supply circuits 668, and this limits the power that can be drawn out of that circuit (for example, the National Electrical Code Article 645.5(A) limits design load to 80% of the maximum current capacity of the branch circuit.). The circuit breakers may also use the circuit protector 210 described in FIG. 2. For example, the circuit breakers can disconnect the circuit using a solid-state interrupter in a specified time. The circuit breaker has a controller that can further instruct a mechanical interrupter to physically open the circuit, as discussed in FIG. 5. Enforcement at the circuit level is straightforward, because circuits are typically not shared between users.

At higher levels of the power distribution system, larger power units are more likely to be shared between multiple different users. The data center operator must provide the maximum rated load for each branch circuit up to the contractual limits and assure that the higher levels of the power distribution system can sustain that load. Violating one of these contracts can have steep penalties because the user may be liable for the outage of another user sharing the power distribution infrastructure. Since the operator typically does not know about the characteristics of the load and the user does not know the details of the power distribution infrastructure, both tend to be very conservative in assuring that the load stays far below the actual circuit breaker limits. If the operator and the user are the same entity, the margin between expected load and actual power capacity can be reduced, because load and infrastructure can be matched to one another.

A number of implementations have been described. Nevertheless, various modifications may be made. Further, steps can be performed in addition to those illustrated in method 500, and some steps illustrated in method 500 can be omitted without deviating from this disclosure. Further, various combinations of the components described herein may be provided for implementations of similar apparatuses. Accordingly, other implementations are within the scope of This disclosure.

1. A circuit protection device comprising:
a solid-state interrupter operable to open a circuit within a specified response time upon detection of a fault current state in the circuit;
a mechanical interrupter connected in series with the solid-state interrupter, the mechanical interrupter operable to open the circuit subsequent to the opening operation of the solid-state interrupter; and
a controller coupled with the solid-state interrupter and the mechanical interrupter to control the mechanical interrupter for coordinated operation with the solid-state interrupter,
wherein the controller is operable to receive a signal, generated based on the detection of the fault current state in the circuit, from the solid-state interrupter indicating an opening of the circuit by the solid-state interrupter and, in response to receipt of the signal, command the mechanical interrupter to open,
the signal from the solid-state interrupter comprises a switch signal that includes a step-up/step-down voltage profile output from the solid state interrupter that commands the controller to open the mechanical interrupter, the switch signal comprising a normal level that indicates a closed state of the solid-state interrupter, and at least one of the step-up voltage output or the step-down voltage output indicates an open state of the solid-state interrupter, and the specified response time is between about one microsecond and about 500 microseconds.

2. The circuit protection device of claim 1, wherein the specified response time is between about two microseconds and about twenty microseconds.

3. (canceled)

4. The circuit protection device of claim 1, wherein the controller comprises an interlock logic, the controller further operable to: command the mechanical interrupter to close the circuit prior to commanding the solid-state interrupter to close the circuit upon receipt of the signal from the solid-state interrupter.

5. The circuit protection device of claim 4, wherein the interlock logic is further operable to automatically reset the mechanical interrupter to a closed status and to subsequently close the solid-state interrupter when the alternating voltage of the circuit reaches zero.

6. The circuit protection device of claim 1, further comprising at least one current sensor operable to measure current magnitude and a first temporal derivative of the current magnitude.

7. The circuit protection device of claim 6, wherein the at least one current sensor is operable to separately calculate a first temporal derivative based on the measured current magnitude for determining the fault current state.

8. The circuit protection device of claim 1, wherein the mechanical interrupter comprises a vacuum interrupter.

9. The circuit protection device of claim 1, wherein the circuit protection device is deployed in a single phase of a three-phase electric power device.

10. A method for interrupting a flow of current through a phase of a circuit comprising:
detecting a fault current state in the phase;
opening the phase of the circuit using a solid-state interrupter within a specified response time;
receiving, from the solid-state interrupter, a signal generated based on the detecting of the fault current state in the phase that indicates the opening of the phase of the circuit at the solid-state interrupter; and
based on the received signal that indicates the opening of the phase of the circuit at the solid-state interrupter, commanding a mechanical interrupter that is positioned in series with the solid-state interrupter in the phase to open, wherein the signal from the solid-state interrupter comprises a switch signal that includes a step-up/step-down voltage profile output from the solid state interrupter that commands the controller to open the mechanical interrupter, the switch signal comprising a normal level that indicates a closed state of the solid-state interrupter, and at least one of the step-up voltage output or the step-down voltage output indicates an open state of the solid-state interrupter,
wherein the specified response time is between about one microsecond and about 500 microseconds.

11. The method of claim 10, further comprising:
automatically resetting the mechanical interrupter to a closed status; and
closing, upon resetting, the phase of the circuit using the solid-state interrupter when the alternating voltage of the phase reaches zero.

12. The method of claim 10, wherein the specified response time is between about two microseconds and about twenty microseconds.

13. The method of claim 12, wherein the specified response time is about five microseconds.

14. The method of claim 10, further comprising:
measuring a current in the circuit using at least one current sensor; and
detecting the fault current state based on a first temporal derivative of the current exceeding a predefined threshold value.

15. A circuit breaker comprising:
a solid-state interrupter comprising an input operable to receive a first phase of a three-phase electric circuit, the solid-state interrupter configured to open the first phase of the circuit within a specified response time upon detection of a fault current state and transmit a signal indicating the opening of the first phase of the circuit, the signal generated based on the detection of the fault current state, the specified response time between about one microsecond and about 500 microseconds; and
a mechanical interrupter positioned in series with the solid-state interrupter on the first phase and comprising:
an input operable to receive the first phase of the three-phase electric circuit; and
an output electrically coupled to the solid-state interrupter,
wherein the mechanical interrupter is configured to receive a command to open based on the signal transmitted from the solid-state interrupter, and
the signal from the solid-state interrupter comprises a switch signal that includes a step-up/step-down voltage profile output from the solid state interrupter that commands the controller to open the mechanical interrupter, the switch signal comprising a normal level that indicates a closed state of the solid-state interrupter, and at least one of the step-up voltage output or the step-down voltage output indicates an open state of the first phase of the circuit by the solid-state interrupter.

16. The circuit breaker of claim 15, further comprising a controller coupled with the solid-state interrupter and the mechanical interrupter, the controller operable to detect a fault current state in the circuit and to control the mechanical interrupter to open, upon a determination of the fault current state, the first phase subsequent to an initial current interruption by the solid-state interrupter.

17. The circuit breaker of claim 15, wherein the solid-state interrupter further comprises at least one insulated-gate bipolar transistor for interrupting the first phase of the electric circuit upon detecting the fault current state within the specified response time being about five microseconds.

18. The circuit breaker of claim 15, wherein the solid-state interrupter comprises a first solid-state interrupter, and the mechanical interrupter comprises a first mechanical interrupter, the circuit breaker further comprising:
a second solid-state interrupter comprising an input operable to receive a second phase of the three-phase electric circuit; and;
a second mechanical interrupter positioned in series with the second solid-state interrupter on the second phase and comprising:
an input operable to receive the second phase of the three-phase electric circuit; and
an output electrically coupled to the second solid-state interrupter.

19. The circuit breaker of claim 18, wherein the controller is communicably coupled with the second solid-state interrupter and the second mechanical interrupter.

20. The circuit breaker of claim 15, further comprising a current sensor per phase operable to measure current magnitude and a first temporal derivative of the current magnitude.

21. (canceled)

22. The circuit protection device of claim 1, wherein the controller is configured to send a trigger signal to the mechanical interrupter upon receiving the signal from the solid-state interrupter.

23. (canceled)

24. The method of claim 10, further comprising sending a trigger signal to the mechanical interrupter upon receiving the signal from the solid-state interrupter.

25. (canceled)

26. The circuit breaker of claim 16, wherein the controller is configured to send a trigger signal to the mechanical interrupter upon receiving the signal from the solid-state interrupter.
